(19) United States
(12) Patent Application Publication
(10) Pub. No.: US 2015/0213376 A1
(43) Pub. Date: Jul. 30, 2015

(54) METHODS AND SYSTEMS FOR GENERATING CLASSIFIERS FOR SOFTWARE APPLICATIONS

(71) Applicant: Shine Security Ltd., Herzlia Pituach (IL)

(72) Inventors: Ianir IDESES, RaAnana (IL); Assaf NEUBERGER, RaAnana (IL)

(21) Appl. No.: 14/608,346

(22) Filed: Jan. 29, 2015

Related U.S. Application Data
(60) Provisional application No. 61/933,366, filed on Jan. 30, 2014.
(60) Provisional application No. 61/942,049, filed on Feb. 20, 2014.
(60) Provisional application No. 61/950,304, filed on Mar. 10, 2014.

(51) Int. Cl. G06N 99/00; H04L 29/08

(52) U.S. Cl. CPC G06N 99/005; H04L 67/10

(57) ABSTRACT

There is provided a method for training a classifier for classifying applications, comprising: identifying, at a central server, features from training software applications; identifying a classification effectiveness rank for each of the features, wherein the classification effectiveness rank defines a difference in accuracy of classification of a respective of the training software applications with and without extraction of the feature; identifying resource requirements of each of the features of each of the training software applications; combining the classification effectiveness rank and the resource requirements for each of the features of each of the training software applications to select a group of classifying features from the features; generating a classifier for evaluating software applications based on the group of classifying features; and providing the classifier to a resource limited client terminal, for feature extraction and classification of a software application locally by the client terminal.

### RELATED APPLICATIONS

This application claims the benefit of priority under 35 USC §119(e) of U.S. Provisional Patent Application Nos. 61/933,366 filed Jan. 30, 2014, 61/942,049 filed Feb. 20, 2014 and 61/950,304 filed Mar. 10, 2014, the contents of which are incorporated herein by reference in their entirety.

### BACKGROUND

The present invention, in some embodiments thereof, relates to a methods and systems for generating classifiers for software applications and, more specifically, but not exclusively, to methods and systems for generating classifiers for software applications based on large feature vectors.

Mobile devices such as Smartphones have increased in software sophistication. Contemporary mobile operating systems allow installation of third party applications. Some operating systems use a walled garden approach. Other operating system platforms allow installation of any application, for example, either from an official application store, or any other source. Furthermore, some platforms allow installation of applications from any computer in a process that is sometimes called sideloading.

As a direct consequence of the openness to third party applications (apps), many vendors have started developing for these platforms. In order to support the development of applications, mobile advertising networks have emerged. Together with the development of ad networks, adware (advertisement software) have also begun to crop up. These adware take advantage of existing ad networks and create application whose main purpose is display of ads on the device. These ads may take the form of banners, intrusive notifications and click hijacking.

Solutions for detection of such adware applications are available, for example, in the form of anti malware software. Such software relies mostly on signature based algorithms. These can take the form of black lists of applications or file signatures.

### SUMMARY

According to an aspect of some embodiments of the present invention there is provided a method for training a classifier for classifying applications on a resource limited client terminal, comprising: identifying, at a central server, a plurality of features from each of a plurality of training software applications; identifying a classification effectiveness rank for each of the plurality of features of each of the plurality of training software applications, wherein the classification effectiveness rank defines a difference in accuracy of classification of a respective of the plurality of training software applications with and without extraction of the feature; identifying resource requirements of each of the plurality of features of each of the plurality of training software applications; combining the classification effectiveness rank and the resource requirements for each of the plurality of features of each of the plurality of training software applications to select a group of classifying features from the plurality of features; generating a classifier for evaluating software applications based on the group of classifying features; and providing the classifier to a resource limited client terminal, for feature extraction and classification of a software application locally by the client terminal.

According to some embodiments of the present invention, generating the classifier for evaluating software applications comprises pruning a complete set of extractable features to select the group of classifying features.

According to some embodiments of the present invention, providing comprises providing the selected group of classifying features to the resource limited client terminal.

According to some embodiments of the present invention, the resource limited client terminal has insufficient resources for local run-time extraction of a complete feature vector of the plurality of features from the software application.

According to some embodiments of the present invention, combining comprises combining to select the group of classifying features based on significance of each of the plurality of features to the classification process.

According to some embodiments of the present invention, combining comprises selecting by reducing the dimensionality of a feature vector of the plurality of features.

According to some embodiments of the present invention, combining comprises selecting based on a lossless operation that does not affect the quality of classification. Optionally, features that correspond to coefficients with zero value are discarded.

According to some embodiments of the present invention, combining comprises selecting based on a lossy operation that is based on a tradeoff during the identifying, between quality of classification and classification performance on the resource limited client terminal.

According to some embodiments of the present invention, combining comprises selecting based on solving a cost function denoting a combination of classifier quality and a measure of complexity attributed each of the plurality of features.

According to some embodiments of the present invention, combining comprises selecting based on coefficients of each of the plurality of features.

According to some embodiments of the present invention, combining comprises selecting for maintaining the classification effectiveness of the classifier based on classification with the selected group of classifying features. Optionally, combining further includes selecting for reducing client terminal processor usage and/or reducing client terminal memory requirements while maintaining the classification effectiveness of the classifier.

According to some embodiments of the present invention, combining comprises selecting for reducing a processor cost of computation of extracting the group of classifying features for run time execution on the resource limited client terminal.

According to some embodiments of the present invention, the features are one or more of: application name, icon, rating, permissions, internal function calls, decompiled byte code, CPU usage, network calls.

According to some embodiments of the present invention, the method further comprises evaluating the effects of the selected group of classifying features on the ability of the classifier to accurately classify software applications.

According to some embodiments of the present invention, multiple classification types are assigned to the software application based on a user context.

According to an aspect of some embodiments of the present invention there is provided a method for classifying applications on a resource limited client terminal, comprising: receiving at a resource limited client terminal, a classifier from a central server, the classifier evaluating a software application based on a selected group of classifying features, the classifying features selected from a plurality of features based on a combination of a classification effectiveness rank and resource requirements of each of the classifying features, wherein the classification effectiveness rank defines a difference in accuracy of classification of a respective software applications with and without extraction of the classifying feature; receiving at the resource limited client terminal, a software application for local run-time classification by the resource limited client terminal; extracting, at the client terminal, the selected group of classifying features from the software application, the extracting performed locally by the resource limited client terminal during run time; and classifying the software application based on the extracted group of classifying features, to generate a classification type for the software application.

According to some embodiments of the present invention, the method further comprises installing or removing the software application based on the classification type.

According to some embodiments of the present invention, the classification type is benign or adware.

According to some embodiments of the present invention, the method further comprises locally generating feature extractors at the resource limited client terminal based on the received group of classifying features, and wherein extracting comprises extracting based on the locally generated feature extractors.

According to some embodiments of the present invention, the extracting is performed during run-time based on the computing resource availability of the client terminal. Optionally, different groups of classifying feature are extracted during run-time based on the available resources of the client terminal.

According to some embodiments of the present invention, the method further comprises providing the generated classification type to the central server, to improve the selection of the group of classifying features.

According to some embodiments of the present invention, the resource limited client terminal has insufficient resources for local run-time extraction of a complete set of classifying features from the software application.

According to an aspect of some embodiments of the present invention there is provided a system for classifying software applications on a resource limited client terminal, comprising: a central server; a first non-transitory memory having stored thereon program modules for instruction execution by the central server, comprising: a module for identifying a classification effectiveness rank for each of the plurality of features of each of a plurality of training software applications, wherein the classification effectiveness rank defines a difference in accuracy of classification of a respective of the plurality of training software applications with and without extraction of the feature; a module for identifying resource requirements of each of the plurality of features of each of the plurality of training software applications; a module for combining the classification effectiveness rank and the resource requirements for each of the plurality of features of each of the plurality of training software applications to select a group of classifying features from the plurality of features; a module for generating a classifier for evaluating software applications based on the group of classifying features; and a module for providing the classifier to a resource limited client terminal, for feature extraction and classification of a software application locally by the client terminal.

According to some embodiments of the present invention, the system further comprises: at least one resource limited client terminal comprising: a resource limited processor; and a second non-transitory memory having stored thereon program modules for local instruction execution by the resource limited processor, comprising: a feature extractor module for local run-time execution by the resource limited processor, the feature extractor module programmed for extracting features from a software application based on the selected group of classifying features received from the central processor; and a trained classifier module for local run-time execution by the resource limited processor, the trained classifier programmed for classifying the software application based on the extracted classifying features. Optionally, the system further comprises a synchronization module for receiving the classifier from the central processor. Optionally, the at least one resource limited client terminal has insufficient resources for run-time extraction of the complete feature set. Optionally, the at least one resource limited client terminal processor is selected from: mobile phone, Smartphone, tablet, portable media player, e-reader. Optionally, the system further comprises a data repository in electrical communication with the central server for storing extracted features, the at least one resource limited client terminal having access to the data repository for guiding the extraction of the feature extraction module. Optionally, the trained classifier module classifies the software application based on coefficients computed by the central processor.

According to some embodiments of the present invention, the system further comprises a network for providing communication between the central server and at the resource limited client terminal.

According to some embodiments of the present invention, the central server contains sufficient resources for extracting a complete feature set and training a classifier based on the extracted complete feature set.

According to some embodiments of the present invention, the central server executes instructions independently during the run time of the resource limited client terminal.

According to some embodiments of the present invention, the system further comprises a labeling module for labeling of software application for generating the classifier, the labeling module stored on the first memory.

According to some embodiments of the present invention, the system further comprises a feature extractor module stored on the first memory, the feature extraction module for extraction of data of software applications into complete feature vectors for training the classifier.

According to some embodiments of the present invention, the system further comprises a learning module for training a classifier based on a complete extractable set of classifying features, and a pruning module for selecting the group of classifying features from the complete set of classifying features. Optionally, the learning module generates a set of parameters and/or coefficients for classification, and the pruning module selects a sub-set of parameters and/or coefficients for local run-time feature extraction and/or classification on the resource limited client terminal.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of generating a pruned feature list for classification, in accordance with some embodiments of the present invention;

FIG. 2 is a flowchart of a method of classification based on the pruned feature list, in accordance with some embodiments of the present invention;

FIG. 3 is a block diagram of a system for generating a pruned feature list for classification, and for classification based on the pruned feature list, in accordance with some embodiments of the present invention;

FIG. 4 is a block diagram of the central server for generating pruned feature lists for classification, in accordance with some embodiments of the present invention; and

FIG. 5 is a block diagram of the client terminal for classification based on the generated pruned list, in accordance with some embodiments of the present invention.

### DETAILED DESCRIPTION

An aspect of some embodiments of the present invention relates to systems and methods for selecting a set of classifying features extractable from software applications, in order to generate classifiers, provide the selected group of classifying features (e.g., feature vectors), select coefficients and/or other parameters for classification of software applications. Optionally, the selected group of classification features is a sub-set of the available features (all or some) that may be extracted from a software application. The complete set of features may be pruned to generate the selected group. Alternatively or additionally, the group of classifying features is not selected based on the complete set of available features. Each or some of the classifying features may be selected independently.

The selected features are significant to the classification process. Optionally, the features are selected based on an identified classification effectiveness rank for each of the features. As defined herein, the phrase classification effectiveness rank or classification effectiveness sometimes refers to the contribution of the extracted feature to the accuracy of classification. Optionally, the classification effectiveness rank defines a difference in accuracy of classification of a respective training software application with and without the extracted classification feature. For example, if the accuracy of classification with the feature is 95%, and the accuracy of classification without the feature is 50%, the accuracy in classification based on the feature is 45%, which may significant for classification effectiveness. Alternatively, classification effectiveness rank may refer to the accuracy of classification based only on the feature, for example, the accuracy of classification based only on the identified feature may be 70%. Values for determining classification effectiveness rank of extracted features may be based on the classification scenario, for example, the number of identified features, the number of total features available for extraction, the importance of accurate classification, and/or other factors. Classification effectiveness rank may also sometimes be referred to as discriminative power. The classification effectiveness rank may be manually selected by the user and/or automatically selected by a software module.

Alternatively or additionally, the classification features are selected based on an identified resource requirements for extracting each of the features. For example, the memory required to extract the feature, the processor usage required to extract the feature, the time to extract the feature, and/or other factors.

Optionally, the classification effectiveness rank and/or resource requirements are identified for each of a multiple of features extracted from multiple training software applications.

Optionally, the classification effectiveness rank and the resource requirements are combined for each of the extracted features to select the group of classifying features from the set of available extractable features.

Alternatively or additionally, identified classifying features are pruned from the set of available features (complete set or partial set) to generate the selected group of classifying features. Alternatively or additionally, identified classifying features are retained within the complete set to generate the selected group of classifying feature, with non-identified features being removed.

The selected group of classifying features may be arranged into a feature vector, matrix, list, or other suitable data structure.

Optionally, selection of the feature vector and/or classifier is performed to prune extracted features that do not contribute to the classification process. Alternatively or additionally, remaining features are significant to the classification process.

Optionally, selection is performed in a lossless manner, that does not affect the quality (e.g., accuracy) of the classification. Alternatively or additionally, identification is performed for feature pruning in a lossy manner, in which quality (e.g., accuracy) of the classification is reduced. The lossy method may be a trade-off.

Optionally, selection is performed as a trade-off between reduction of classification ability and reduction in the number of extracted features. The reduction in the number of extracted features may improve run-time performance when locally executed by the resource limited mobile devices. Optionally, selection is based on reducing processor usage of the mobile device, and/or reducing memory requirements of the mobile device, while maintaining the classification effectiveness and/or discriminative power of the classifier. Alternatively or additionally, selecting is based on a cost function. The cost function may denote a combination of classifier quality and a measure of complexity attributed to the features.

Optionally, selecting maintains the classification effectiveness and/or discriminative power of the classifier, when classification is performed based on the pruned feature set.

In one example of the trade-off, a certain feature may have strong classification effectiveness and/or discrimination capability, but may place large requirements in terms of memory and/or CPU usage. A different feature may have slightly less classification effectiveness and/or discrimination capability, but significantly lower CPU and/or memory usage. The latter feature may be selected (i.e., maintained in the feature set) over the former feature (i.e., pruned from the feature set), for example, by a cost algorithm and/or other methods.

Optionally, the classification features are selected based on the ability to execute the feature extraction and/or classification locally, during run-time on resource limited client devices, for example, mobile devices such as mobile phones, Smartphones, tablets, portable media players, e-readers, or other resource limited devices. Optionally, the classifying feature group and/or classifier is generated at a central processor, and provided to the resource limited client device, for local run-time execution on the resource limited client device. The classifying feature group is a selected sub-set of the complete feature set, the selection performed for local run-time execution on the resource limited client. The central processor may have sufficient resources (e.g., processor ability, memory) for extraction of the complete set of features (e.g., off-line or during run-time). The client terminal may have insufficient resources (e.g., processor, memory) for local run-time extraction of the complete set of features and/or classification based on the complete feature set, but may have sufficient resources for local run-time extraction of the selected classifying feature group and/or classification based on the selected classifying feature group.

The selected classifying feature group may be a pruned feature set, selected from a larger set (complete or partial) of extractable features. Feature pruning may be based on the complete feature vector. The complete feature vector may refer to the initial large set of features that are then pruned, and/or the set of all possible features that may be extracted, or other large numbers of features.

Optionally, the classifier classifies software applications on the mobile device based on the selected group of classifying features. Optionally, the software applications are classified prior to installation on the mobile device. Optionally, the classification is performed locally during run-time to detect malicious and/or unwanted software applications, for example, adware, viruses, spyware, or other such software applications.

Extraction of a full set of features from the software application to perform the classification may be resource intensive. A full set of features extracted from a software application may number in the hundreds of thousands. The full extraction may require significant amounts of time, significant central processor unit (CPU) availability, large memories, ability to execute instruction off-line, and/or other requirements. The central server (e.g., server, computer, distributed computing network, or other computers) may have the resources for extraction of the full set of features.

The mobile devices may be resource limited, unable to extract the full set of features during run-time, and/or unable to perform the extraction within a reasonable amount of time to allow for run-time operation, such as in less than about 3 seconds or less than about 7 seconds. For example, the mobile devices may have smaller CPUs, more concurrent processing requirements (e.g., maintaining active network connection applications), requirements for run-time execution of programs (e.g., immediate response as opposed to off-line processing) less available memory, or other strains on resources, for example, as compared to larger computers, desktop computers, network servers, or other computers generally able to execute classification algorithms offline, and/or within a reasonable time frame.

According to some embodiments of the present invention, the full set of features is extracted at a central server with the available resources to perform the full extraction. Optionally, a classifier is trained based on the extracted full set of features. The trained classifier is pruned, feature coefficients are selected, the dimensionality of the feature vector is reduced and/or the size of the extracted feature set is reduced. The pruning and/or dimensionality reduction is performed so that classification may take place during run-time with the resource availability of the mobile device. The pruned feature set, selected feature coefficients, and/or classifier is provided to the mobile device, for performing local run-time feature extraction and classification of software applications. In this manner, the mobile device may detect malicious and/or otherwise unwanted software applications. Installation of the detected unwanted software applications may be prevented.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

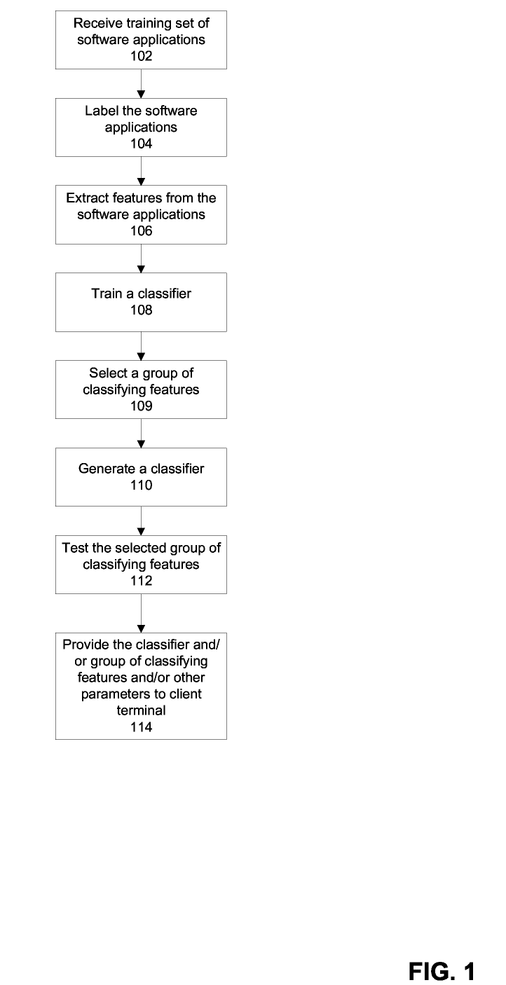

Reference is now made to FIG. 1, which is a method of generating a selected group of classifying features (e.g., feature vector) for classification of software applications, in accordance with some embodiments of the present invention. Optionally, the selected group of classifying features is generated by a processor with sufficient resources to generate a full feature list, for example, a network server, a desktop computer, a distributed computer network, or other powerful processing entities. The full feature list is optionally selectively pruned to generate a pruned feature list. Alternatively or additionally, each feature of the group is selected from-the-ground-up; added to the group as opposed to removed from or retained within a larger group. Optionally, the features are identified based on a combination of a classification effectiveness rank and/or resources required for extraction of the feature. Optionally, the selected group of classifying features is designed for execution during operation run-time on a mobile device (or other resource limited client terminal). Optionally, the identification and/or pruning is selectively performed based on a trade-off, between reducing the number of features (which may allow execution with fewer resources, such as memory and/or CPU) and maintaining the ability to accurately classify based on the reduced feature set.

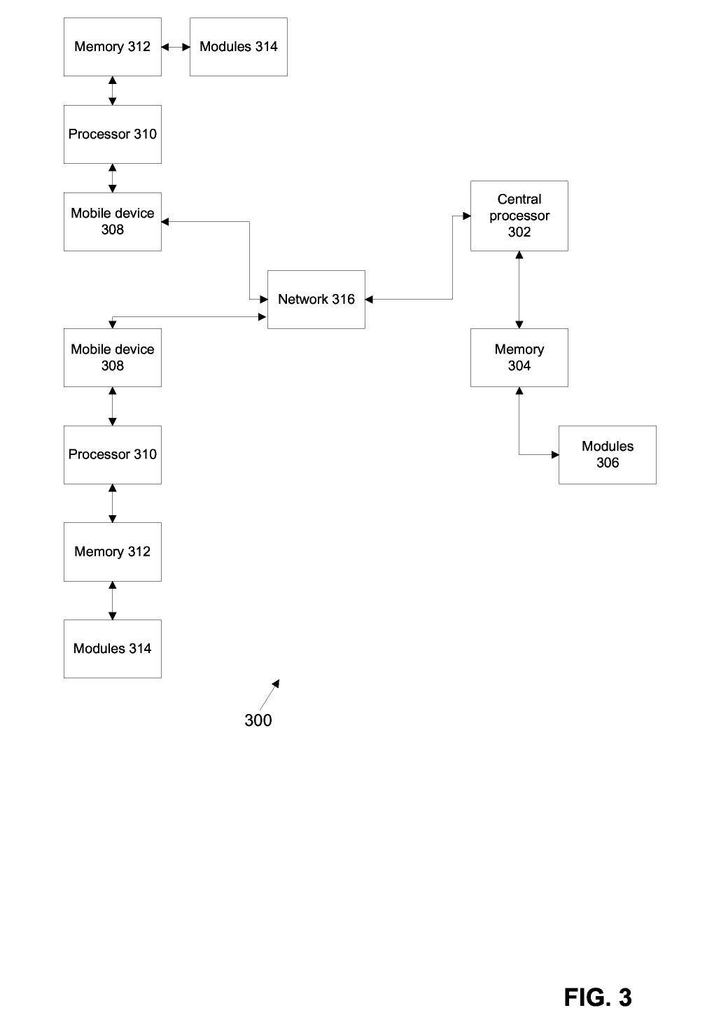

Reference is also made to FIG. 3, which is a system 300 for generating a selected group of classifying features for classification, and for classifying based on the selected group. Optionally, system 300 classifies software applications (e.g., adware) on a mobile device 308 during runtime.

System 300 includes a central processor 302 with a memory 304 for storing data modules 306 thereon. Central processor 302 may be a dedicated server, made from dedicated software and/or hardware, a distributed processing network, a desktop computer, or other resource intensive processing entities. Central processor 302 may have sufficient processing ability to train a classifier based on a full set of features, for example, extracted from software applications. The full set of features may be on the order of hundreds of thousands of features. Memory 304 may be large enough and/or fast enough to store the full set of extracted features.

Modules 306 may include a feature extraction and/or pruning system. The feature extraction and/or pruning may take place off-line, for example, as part of an initialization process to generate the selected group of classifying features before software application classification may proceed on the mobile devices.

Central processor 302 may communicate with one or more mobile devices 308, such as client terminals, Smartphones, or other devices. Mobile devices 308 may be resource limited, having smaller and/or less powerful processor 310, and/or smaller and/or slower memory 312. Modules 314 are stored on memory 312 for execution by processor 310.

Modules 314 may include a run-time feature extractor for extracting features from a software application for classification based on the selected group of classifying features, and/or a run-time classifier for classifying the software application based on the selected group of classifying features.

Central processor 302 and mobile device 308 may communicate with each other through a network 316. For example, through the internet, a local area connection, a wide area connection, a cellular connection, a wired connection, other networks, a Bluetooth™ connection, a USB cable, and/or combinations thereof. Central processor 302 and mobile device 308 may be remotely located from one another. Alternatively, central processor 302 and mobile device 308 may be local to one another, for example, central processor 302 is a desktop computer that is synchronized with a related mobile device 308.

In accordance with some embodiments of the present invention, central processor 302 generates the selected group of classifying features, the selected coefficients, and/or the trained classifier. The selected group of classifying features and/or the trained classifier is then provided to client devices 308 for local run-time classification, for example, classification of software applications.

The method of FIG. 1 may be performed by central processor 302.

Referring back to FIG. 1, optionally, at 102, multiple software applications for training the classifier are received, for example, by central processor 302. The software applications may be manually provided by an operator of the system (e.g., the manufacturer), provided by software application manufacturers, automatically downloaded from the internet, provided by updates from mobile devices 308 that are part of system 300, and/or provided by other methods.

Optionally, at 104 the multiple software applications are labeled with a classification type based on desired software application classification categories. For example, the classification types denote desired or undesired software applications. Labeling may be performed manually (e.g., by the user) and/or automatically (e.g., by a labeling module 306 stored on memory 304). Labeling may be automatically performed, for example, using application programming interfaces (APIs) to label sources. Labeling may be manually performed, for example, using an interactive software module that requires user intervention.

Examples of labeling software applications include: previously labeled applications that were vetted by commercial companies, signature based tools for automatic labeling, mechanical turk methods to systematically analyze a large set of applications of the different classes, and/or other labeling methods.

Examples of labels include: Adware, Goodware, Intrusive Adware, or other classification types may be used.

Optionally, the output of the labeling module is a list of the software applications with a corresponding classification type. Labeling may be a 1:1 mapping, or may be other mapping methods that are not 1:1. Optionally, labeling is performed within a certain context, for example a user context, to determine the possible classification types for different users. For example, for different classification tasks, the same software application may have a different label. For example, for some users, a software application that displays the latest sales by stores in the neighborhood may be classified as intrusive. The same software application displaying the sales may be classified for other users are desirable.

Alternatively or additionally, a non-supervised approach is used in which labeling is based on clusterization. Optionally, clusters are generated automatically using a non-supervised and/or a semi-supervised clustering software module. The classes taken from these algorithms may be assigned arbitrary names and/or meaningful names when correlations are identified.

Optionally, at 106, features are extracted from the software applications, for example, by a feature extractor module 306 stored on memory 304. Optionally, a complete set of features is extracted from each application. Alternatively, individual or groups of features are extracted from each application, for example, as features are being evaluated for inclusion in the group of classifying features. Optionally, a feature vector is extracted.

Optionally, multiple feature extraction modules apply multiple feature extraction algorithms to extract the multiple features. For example, native operating system (OS) system calls, temporal polling, application monitoring, and/or other methods. Some features are acquired by a decompiling process, for example, translating the code (e.g., Java byte) into human readable code.

Optionally, the feature extraction module extracts data and/or meta data from the software applications. Optionally, the feature extraction module stores the extracted data, for example, in an extraction database stored on memory 304.

The extracted features may be any feature that describes the software application. The extracted features may be varied, containing information from different modalities. For example, the extracted features may contain static meta data regarding the application, for example, icon, name, rating or other features. In another example, the extracted features may contain information regarding the executable code and/or software package, for example, in the form of byte code, resources, permissions, or other features. In yet another example, another modality of features may include behavioral features, for example, temporal information regarding system calls, system usage, CPU usage, network utilization, or other features. The features may include suitable data and/or meta data that may be extracted from the software application and/or computed. Examples of extracted features include: application name, icon, rating, permissions, internal function calls, decompiled byte code, behavioral properties such as network, CPU, user interface (UI), and/or system calls usage, and/or other suitable quantifiable measures that may be obtained for the software application.

Extraction of the complete set of features may be time consuming, and/or CPU resource intensive. The feature extraction may take place off-line, not part of a run-time operation.

Optionally, the feature extraction module orders the features and/or stores the features in ordered buffers, for example, on memory 304. Optionally, the features are stored as feature vectors, which may be used for training the classifier. The features may be stored using other data structures, for example, a matrix, a list, or other suitable structures.

Extraction of the full set of features may not be possible during run-time on the mobile device. Extraction of the full set of features may take place at the central processor, independently of run-time operation of the mobile device, for example, before classification may proceed by the mobile device.

The extracted features may be stored, for example, within memory 304 or other suitable data repository, such as a local database.

Optionally, at 108, a classifier is trained based on the set of extracted features (block 106) and software classification labeling (block 104). Optionally, a learning module 306 (e.g., stored on memory 304) of a machine learning algorithm is applied to train the classifier. A single classifier or multiple classifiers may be used. For example, a combination of classifiers may be applied to classify feature vectors, for example a cascade of classifiers, a boosting topology of classifiers, or a parallel classification scheme.

Optionally, the learning module performs the machine learning and/or classifier training.

Optionally, the classifier is trained based on supervised learning. Examples of software modules to train the classifier include: Neural Networks, Support Vector Machines, Decision Trees, Hard/Soft Thresholding, Naive Bayes Classifiers, or any other suitable classification system and/or method. Alternatively or additionally, the classifier is trained (and/or machine learning takes place) based on unsupervised learning, for example, k-Nearest Neighbors (KNN) clustering, Gaussian Mixture Model (GMM) parameterization, or other suitable unsupervised methods.

Optionally, the classifier training generates a vector and/or matrix of coefficients and/or other parameters, and/or a set and/or tree of decision rules. The nodes and/or positions in the vector and/or matrix may be attributed to specific features in the feature vector.

At 109, a group of classifying features is selected, for example, by a combination and/or selection module 306 stored on memory 304. Optionally, each features of the group is individually (or in combination) identified and added to the group. Alternatively or additionally, extracted features are identified for pruning to generate the group of classifying features, for example, by an identification module 306 stored on memory 304.

Optionally, the selection is based on identifying a classification effectiveness rank for each of the features of the training software applications. Alternatively or additionally, the selection is performed based on identifying resource requirements for each of the features of the training software applications.

Optionally, the selection is based on a combination of classification effectiveness rank and the resource requirements for each of the features.

Optionally, the selection module uses the parameters and/or coefficients gathered during the classification training (block 108).

The pruning process may be lossless or lossy, for example, based on different selection and/or pruning methods.

Optionally, the group of classifying features is selected to allow calculation and/or extraction of the features during run-time on the mobile device. Extraction of the full set of features may not be possible on the mobile device, during run-time and/or based on the CPU and/or memory requirements. Extraction of the group of classifying features may be possible on the mobile device during run time. Performing the classification on the extracted feature vector may be a simple, resource inexpensive mathematical operation.

The group of classifying features may be selected based on one or more methods.

Optionally, the group of classifying features is selected to reduce the dimensionality of the feature vector.

Optionally, the group of classifying features is selected based on the significance of the extracted features. Significant features, such as those that have a large effect on the classification outcomes, may be retained. Insignificant features, such as those that have a small, negligible or no effect on classification outcome may be pruned.

Optionally, features (or their equivalents) that do not contribute (or do not significantly contribute) to the classification process are pruned or not included. Optionally, pruning and/or selection is a lossless operation that does not affect the quality of the classification. Optionally, features that correspond to coefficients having a value of zero are pruned or not included, for example, when classification is performed based on a support vector machine (SVM). Alternatively or additionally, features with a low magnitude value of the coefficient are identified for pruning and/or are not included. The magnitude of the coefficient may be measured, for example, linearly on a logarithmic scale, or based on other suitable scales.

Optionally, removal or failure to include features with non-zero coefficients may be a lossy operation. Optionally, the group of classifying features is selected based on a trade-off. Optionally, the tradeoff is between the quality of classification and the decrease in feature extraction.

Selection of the group of classifying features based on coefficients with zero value may be denoted by the expression:

FeatureᵢεFVif|(Coefficientᵢ)|≠0

Selection of the group of classifying features based on coefficients with low values may be denoted by the expression:

FeatureᵢεFVif|(Coefficientᵢ)|≧α

Optionally, the group of classifying features is selected based on solving a cost function. Optionally, solving the minimum function may lead to efficiently targeted dimensionality reduction. Optionally, the cost function denotes a combination of classifier quality (i.e., ability to accurately classify) and the measure of complexity attributed to the features of the feature vector. Solving the cost function (e.g. to obtain the minimum cost) may provide an optimum set of features for a given required classifier performance level.

Selection of the group of classifying features based on solving the cost function may be denoted by the expression:

{Fvᵢ}=argmin(α*coeffᵢ+β*computationalCostᵢ)

Optionally, the dimensionality reduction of the group of classifying features and/or feature pruning is selectively performed based on the tradeoff of improving classification ability, while reducing CPU requirements and/or while reducing memory usage. The trade-off may be denoted by the expression:

cost(feature)=α*CPU(feature)+β*Memory(feature)−γ*detection(feature)

For example, a certain feature may have good discrimination capability, but may place large demands on memory and/or CPU usage. In comparison, a different feature may have slightly less discrimination capability, but may also place significantly lower CPU usage and/or memory usage demands. The overall cost of the latter feature may be lower than the cost of the former feature. The latter feature may be selected as part of the feature vector. The former feature may be selected for pruning or otherwise not included.

At 110, a classifier is generated, for example, by a classifier generating module 306 stored on memory 304.

Optionally, the classifier is generated based on the group of classifying features. The classifier may be trained based on the selected group of classifying features. Alternatively or additionally, the feature set used to generate the trained classifier (block 108) is pruned. Alternatively or additionally, the feature set used to generate the trained classifier (block 108) is pruned to generate a trained pruned classifier.

Optionally, the full set of features is pruned to a reduced list of the identified features. Alternatively or additionally, the full set of features is pruned to a reduced list, by removing the identified features. Optionally, the number and/or size of the feature vector is reduced. Optionally, the pruning module reduces the dimensionality of the feature vector. Optionally, the dimensionality is reduced based on the parameters and/or coefficients.

Optionally, at 112, the group of classifying features, the generated classifier and/or reduced dimensionality of the feature vector are evaluated, for example, by an evaluation module 306 stored on memory 304. For example, classifier performance based on the pruned feature set is compared to classifier performance based on the complete feature set. In another example, classifier performance based on the group of classifying features is evaluated against a predefined threshold, such as a predefined level of accuracy in classification. Testing may be performed to evaluate one or more parameters, for example: certainty of the classification, ability to execute in run-time on the mobile device, time for execution, CPU utilization, memory requirement, and/or other evaluation criteria.

The pruning may be selectively adjusted based on the testing. Alternatively or additionally, the members of the group of classifying features may be adjusted. For example, if testing indicates inability to execute on the mobile device, additional features may be pruned from the group. For example, if testing indicates low CPU resource requirements, additional features may be added back to the group to improve classification performance while remaining within the allowable CPU usage requirements.

At 114, the group of classifying features, the pruned feature vector, selected coefficients, and/or trained classifier are provided to the mobile device. For example, the mobile device downloads the trained classifier from the central server, a synchronization module 314 on the mobile device (e.g., memory 312) detects an update of the group of classifying features and automatically downloads the updated version to the mobile device, the central server automatically uploads the latest version of the pruned feature vector to the mobile device, and/or other methods of providing the pruned feature vector to the mobile device.

The group of classifying features, selected coefficients and/or trained classifier may be provided over network 316, over a cable, through a local wireless connection, on a computer readable media (e.g., memory card, CD, or other media), or using other methods.

The group of classifying features, selected coefficients and/or trained classifier are provided to the mobile device for run-time classification of software applications by the mobile device.

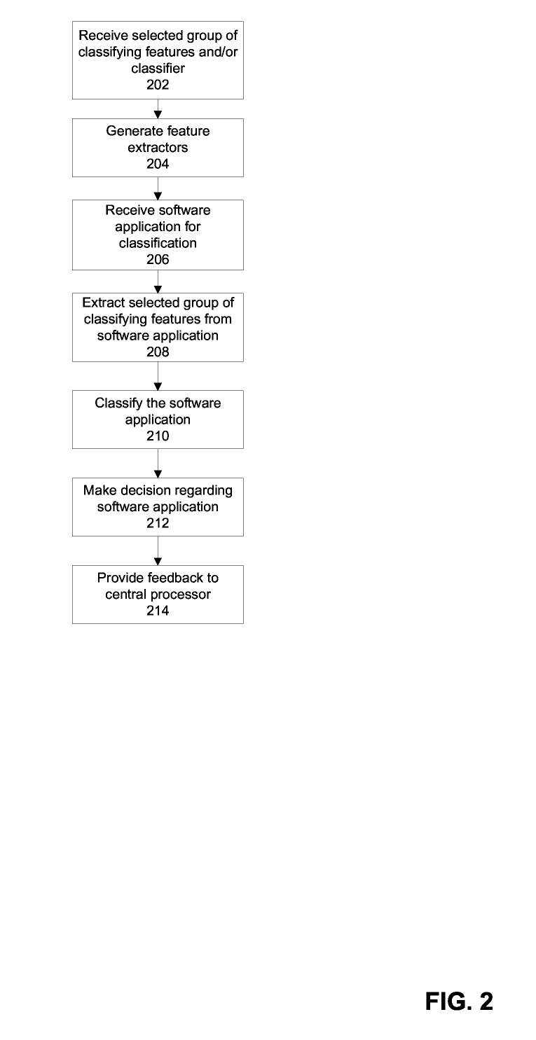

Reference is now made to FIG. 2, which is a flowchart of a method of run-time execution of a classifier based on a pruned feature list, in accordance with some embodiments of the present invention. The method of FIG. 2 may be executed by mobile device 308 of FIG. 3. The method of FIG. 2 may provide run-time classification of software applications, the method locally executed by the available resources on the mobile device, for example, to detect if the software application for installation is malware, adware, or benign (e.g., fine for installation).

Optionally, at 202, the group of classifying features, the trained classifier, and/or the pruned list of features (e.g., feature vector) is received by the mobile device, for example, by the synchronization module 314. The group of classifying features may be received from the central server. The group of classifying features has been selected based on the classification effectiveness and/or based on resource requirements of each feature. The list may have been selected to allow run-time execution using the available limited resources of the mobile device.

Alternatively or additionally, a list of feature coefficients is received by the mobile device. Alternatively or additionally, a pruned classifier is received by the mobile device.

Optionally, at 204, feature extractors are generated at the mobile device. Alternatively, the feature extractors are pre-stored and/or pre-loaded modules on the mobile device, for example, having been preprogrammed by the manufacturer.

Optionally, the feature extractor modules are automatically built and coded based on the pruned features that have been selected by the central processor. Optionally, the feature extractors are designed for run time execution using the limited resources available at the mobile device.

Optionally, the feature extractor modules extracts the features that were selected after the dimensionality reduction, as provided from central processor 302 (block 202).

Optionally, the feature extractor module is able to extract the entire feature vector. Alternatively or additionally, the feature extractor module is able to extract the pruned list of features.

Optionally, different sets of features may be extracted. The different sets may be extracted depending on the resource availability of mobile device 308, for example, depending on the CPU availability and/or memory availability. Optionally, different devices, or the same device under different operating conditions, may be able to extract different sets of features during run-time, for example, depending on their CPU architecture or other resource factors. In this manner, the set of extracted features are customized for the mobile device. Devices with more powerful CPUs and/or more memory may extract more features, which may increase the accuracy of classification over devices with less powerful CPUs and/or less memory. The specific set of features may be decided upon and/or extracted during run-time.

Optionally, at 206, a software application is received at the mobile device, for example, the software application is downloaded from the internet, loaded using physical computer readable media, uploaded by a third party, or other methods of receipt. Optionally, the software application is requesting (automatically or manually) to be installed on the mobile device.

At 208, features are extracted based on the software application, for example by the generated feature extraction modules (block 204). Optionally, the features extracted are based on the group of classifying features and/or trained classifier received from the central server (block 202). Optionally, the features are extracted by the generated feature extractors (block 204).

Optionally, features are extracted during run-time. Optionally, features are extracted quickly, within a reasonable period of time for a user to wait, for example, less than about 1 second, or about 3 seconds, or about 5 seconds, or other time periods. Optionally, features are extracted using the available CPU and/or memory of the mobile device, for example, features are extracted as the CPU is processing other concurrent software applications running on the mobile device.

Optionally, the extracted features are collated into feature vectors. The feature vectors may be stored in buffers, which may provide for easy serial access. The feature vectors may be stored on memory 312, for example, within a data repository.

At 210, the software application is classified, for example, by a run-time classification module 314 stored on memory 312. Optionally, the classification module labels the software application. Optionally, the software application is classified, for example, as benign or adware.

Optionally, the classification module is implemented at the mobile device, or at other client terminals that may or may not be mobile, for example, resource limited processors that are stationary.

Optionally, the software application is classified by applying the trained classifier received from the central server. Alternatively or additionally, the software application is classified based on the group of classifying features that have been computed by the feature extractor (block 208). Alternatively or additionally, the classification is based on the received coefficients that have been computed by central processor 302, for example, when classification is performed based on a suitable coefficient related method.

Optionally, the classification module computes the most likely class for the software application.

Optionally, the classification module computes the classification using a statistical classifier set, a deterministic classifier set, or combinations thereof. Classification may be computed by a single method, a cascade of simple classifiers, a dual or a multi-class scenario, or other combinations of different classification methods.

Optionally, a certainty of the classification is provided, for example, the estimated probability that the classification is correct.

Optionally, at 212, a course of action is decided for the software application based on the automated classification. Optionally, the software application is installed on the mobile device, for example, if the classification type is determined to be benign, or other non-harmful and/or beneficial classification types. Alternatively, the software application is not installed, deleted, flagged, or otherwise prevented from functioning on the mobile device, for example, if the classification type is determined to be harmful, malware, bothersome, adware, intrusive, spyware, or other non-desirable classification types.

The decision to install or delete the software application may be performed manually by the user, and/or automatically by a removal module. For example, possibly malicious software applications may be flagged and presented to the user for final decision if to install or remove, together with the potential classification type.

The decision to install or remove the software application may be based on the certainty level. For example, high probability malicious software may be automatically (or manually) removed, or high probability benign software may be automatically (or manually) allowed to proceed.

Optionally, at 214, the mobile device reports back to the server. Optionally, the classification type outcome is reported. Reporting is performed, for example, by sending electronic messages through network 316. Optionally, information regarding the software application is sent back as part of a feedback loop.

Optionally, the central server learns about the existence of new software applications based on the feedback provided from the mobile device.

Optionally, the central server re-labels or confirms the labeling of existing software applications based on the provided feedback. For example, classification results with high certainty received from multiple mobile devices may cause the central server to change the existing classification type, or to retain the existing classification type.

Optionally, the classification labeling is re-enforced based on manual or semi-automatic methods. For example, the user is presented with the automatic classification, and asked to confirm the automatic classification or indicate that the automatic classification is wrong, and/or indicate the correct classification.

The method of FIG. 2 may be automatically executed by software, for example, the mobile device automatically updates itself with the latest feature set, automatically detects software trying to install itself, automatically classifies the software, and/or automatically removes possibly harmful software. Some blocks of the method may be performed manually by the user, for example, requesting an update of the feature set, running the classification program, and/or other blocks.

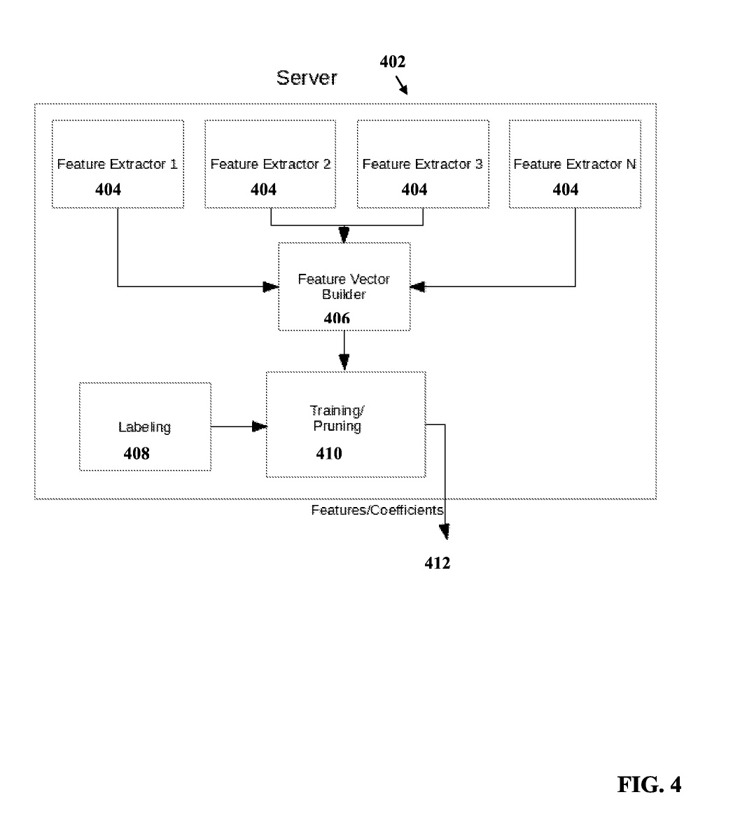

Reference is now made to FIG. 4, which is a schematic block diagram of an exemplary server 402 for generating reduced features and/or coefficients suitable for local run-time classification on a resource limited client terminal (e.g., mobile device), in accordance with some embodiments of the present invention. The interaction and/or operation of the modules within server 402 is based on the method of FIG. 1, and/or central processor 302 of FIG. 3.

Optionally, server 402 is a computer with CPU and/or memory resources for performing complete feature extractions and/or generating a pruned classifier. Server 402 may be a network node.

Multiple feature extractor modules 404 extract a complete set of features from a software application. The extracted features are combined into a feature vector by a feature vector builder 406.

A labeling module 408 labels the software applications.

A classifier is trained by a training module 410, based on the feature vector and associated label of the software applications. A pruning module 410 reduces the size of the feature vector and/or the dimensionality of the feature vector. Pruning module 410 performs pruning so that the classifier maintains a certain level of accurate classification, while being able to perform the classification during run-time at a resource limited client terminal (e.g., mobile device). Optionally, a reduced set of features 412 and/or selected coefficients 412 are provided as an output of server 402. Features 412 and/or coefficients 412 are provided to the client terminal for performing local run-time classification of the software applications using limited resources.

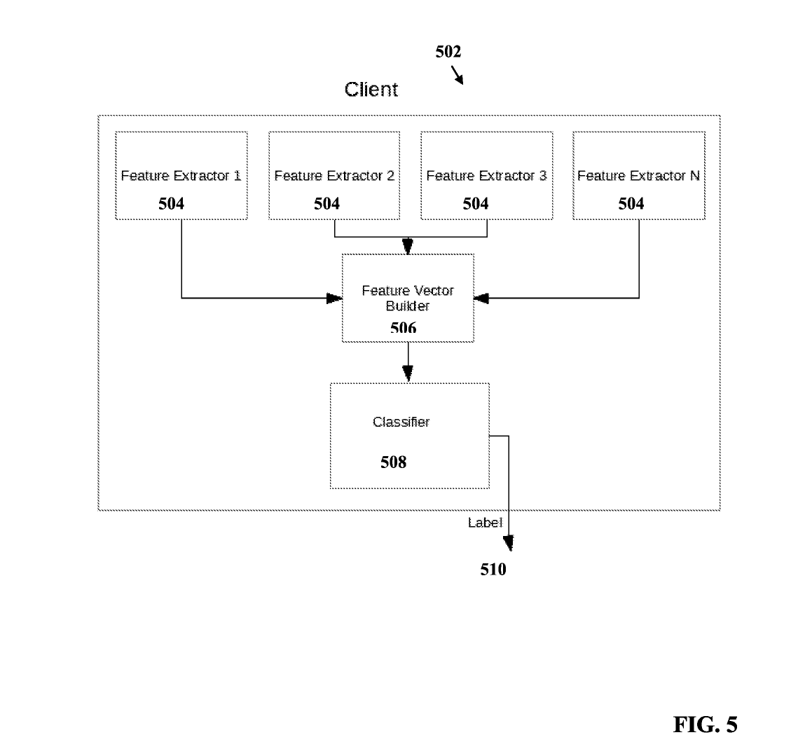

Reference is now made to FIG. 5, which is a schematic block diagram of an exemplary client terminal 502 for performing run-time classification of software applications based on reduced features and/or selected coefficients, in a resource limited environment, in accordance with some embodiments of the present invention. The interaction and/or operation of the modules within client 502 are based on the method of FIG. 2, and/or mobile device 308 of FIG. 3. Client 502 may interact with server 402 of FIG. 4.

Optionally, client 502 is a resource-limited device, having limited CPU availability, limited CPU power, and/or limited memory. For example, client 502 is a Smartphone.

Multiple feature extractor modules 504 extract a limited set of features from a software application. The pruned set of features has been received from server 402 of FIG. 4, such as features 412 and/or coefficients 412. The set of extracted features is selected to take place during run-time, under the available resources of client 502.

A feature vector builder module 506 optionally generates a pruned feature vector out of the multiple extracted features.

A classifier module 508 classifies the software application during run-time, based on the pruned feature vector. Classifier module 508 generates a label 510 for the software application. A decision may be made regarding the software application based on the generated label 510, for example, install the software, delete the software, prompt the user for the next action, or other decisions.

The methods and systems described herein with reference to classification of software applications are not necessarily limited to classification of software applications. The methods and systems described herein may be used to perform other classifications having large feature sets that may not be completely extracted during run-time on resource limited devices.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant software applications, servers and client terminals will be developed and the scope of the terms software applications, servers and client terminals is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for training a classifier for classifying applications on a resource limited client terminal, comprising:
identifying, at a central server, a plurality of features from each of a plurality of training software applications;
identifying a classification effectiveness rank for each of the plurality of features of each of the plurality of training software applications, wherein the classification effectiveness rank defines a difference in accuracy of classification of a respective of the plurality of training software applications with and without extraction of the feature;
identifying resource requirements of each of the plurality of features of each of the plurality of training software applications;
combining the classification effectiveness rank and the resource requirements for each of the plurality of features of each of the plurality of training software applications to select a group of classifying features from the plurality of features;
generating a classifier for evaluating software applications based on the group of classifying features; and
providing the classifier to a resource limited client terminal, for feature extraction and classification of a software application locally by the client terminal.

2. The method of claim 1, wherein generating the classifier for evaluating software applications comprises pruning a complete set of extractable features to select the group of classifying features.

3. The method of claim 1, wherein providing comprises providing the selected group of classifying features to the resource limited client terminal.

4. The method of claim 1, wherein the resource limited client terminal has insufficient resources for local run-time extraction of a complete feature vector of the plurality of features from the software application.

5. The method of claim 1, wherein combining comprises combining to select the group of classifying features based on significance of each of the plurality of features to the classification process.

6. The method of claim 1, wherein combining comprises selecting by reducing the dimensionality of a feature vector of the plurality of features.

7. The method of claim 1, wherein combining comprises selecting based on a lossless operation that does not affect the quality of classification.

8. The method of claim 7, wherein features that correspond to coefficients with zero value are discarded.

9. The method of claim 1, wherein combining comprises selecting based on a lossy operation that is based on a tradeoff during the identifying, between quality of classification and classification performance on the resource limited client terminal.

10. The method of claim 1, wherein combining comprises selecting based on solving a cost function denoting a combination of classifier quality and a measure of complexity attributed each of the plurality of features.

11. The method of claim 1, wherein combining comprises selecting based on coefficients of each of the plurality of features.

12. The method of claim 1, wherein combining comprises selecting for maintaining the classification effectiveness of the classifier based on classification with the selected group of classifying features.

13. The method of claim 12, wherein combining further includes selecting for reducing client terminal processor usage and/or reducing client terminal memory requirements while maintaining the classification effectiveness of the classifier.

14. The method of claim 1, wherein combining comprises selecting for reducing a processor cost of computation of extracting the group of classifying features for run time execution on the resource limited client terminal.

15. The method of claim 1, wherein the features are one or more of: application name, icon, rating, permissions, internal function calls, decompiled byte code, CPU usage, network calls.

16. The method of claim 1, further comprising evaluating the effects of the selected group of classifying features on the ability of the classifier to accurately classify software applications.

17. The method of claim 1, wherein multiple classification types are assigned to the software application based on a user context.

18. A method for classifying applications on a resource limited client terminal, comprising:
receiving at a resource limited client terminal, a classifier from a central server, the classifier evaluating a software application based on a selected group of classifying features, the classifying features selected from a plurality of features based on a combination of a classification effectiveness rank and resource requirements of each of the classifying features, wherein the classification effectiveness rank defines a difference in accuracy of classification of a respective software applications with and without extraction of the classifying feature;
receiving at the resource limited client terminal, a software application for local run-time classification by the resource limited client terminal;
extracting, at the client terminal, the selected group of classifying features from the software application, the extracting performed locally by the resource limited client terminal during run time; and
classifying the software application based on the extracted group of classifying features, to generate a classification type for the software application.

19. The method of claim 18, further comprising installing or removing the software application based on the classification type.

20. The method of claim 18, wherein the classification type is benign or adware.

21. The method of claim 18, further comprising locally generating feature extractors at the resource limited client terminal based on the received group of classifying features, and wherein extracting comprises extracting based on the locally generated feature extractors.

22. The method of claim 18, wherein the extracting is performed during run-time based on the computing resource availability of the client terminal.

23. The method of claim 22, wherein different groups of classifying feature are extracted during run-time based on the available resources of the client terminal.

24. The method of claim 18, further comprising providing the generated classification type to the central server, to improve the selection of the group of classifying features.

25. The method of claim 18, wherein the resource limited client terminal has insufficient resources for local run-time extraction of a complete set of classifying features from the software application.

26. A system for classifying software applications on a resource limited client terminal, comprising:
a central server;
a first non-transitory memory having stored thereon program modules for instruction execution by the central server, comprising:
a module for identifying a classification effectiveness rank for each of the plurality of features of each of a plurality of training software applications, wherein the classification effectiveness rank defines a difference in accuracy of classification of a respective of the plurality of training software applications with and without extraction of the feature;
a module for identifying resource requirements of each of the plurality of features of each of the plurality of training software applications;
a module for combining the classification effectiveness rank and the resource requirements for each of the plurality of features of each of the plurality of training software applications to select a group of classifying features from the plurality of features;
a module for generating a classifier for evaluating software applications based on the group of classifying features; and
a module for providing the classifier to a resource limited client terminal, for feature extraction and classification of a software application locally by the client terminal.

27. The system of claim 26, further comprising:
at least one resource limited client terminal comprising:
a resource limited processor; and
a second non-transitory memory having stored thereon program modules for local instruction execution by the resource limited processor, comprising:
a feature extractor module for local run-time execution by the resource limited processor, the feature extractor module programmed for extracting features from a software application based on the selected group of classifying features received from the central processor; and
a trained classifier module for local run-time execution by the resource limited processor, the trained classifier programmed for classifying the software application based on the extracted classifying features.

28. The system of claim 27, further comprising a synchronization module for receiving the classifier from the central processor.

29. The system of claim 26, further comprising a network for providing communication between the central server and at the resource limited client terminal.

30. The system of claim 26, wherein the central server contains sufficient resources for extracting a complete feature set and training a classifier based on the extracted complete feature set.

31. The system of claim 27, wherein the at least one resource limited client terminal has insufficient resources for run-time extraction of the complete feature set.

32. The system of claim 26, wherein the central server executes instructions independently during the run time of the resource limited client terminal.

33. The system of claim 27, wherein the at least one resource limited client terminal processor is selected from: mobile phone, Smartphone, tablet, portable media player, e-reader.

34. The system of claim 27, further comprising a data repository in electrical communication with the central server for storing extracted features, the at least one resource limited client terminal having access to the data repository for guiding the extraction of the feature extraction module.

35. The system of claim 26, further comprising a labeling module for labeling of software application for generating the classifier, the labeling module stored on the first memory.

36. The system of claim 26, further comprising a feature extractor module stored on the first memory, the feature extraction module for extraction of data of software applications into complete feature vectors for training the classifier.

37. The system of claim 27, wherein the trained classifier module classifies the software application based on coefficients computed by the central processor.

38. The system of claim 26, further comprising a learning module for training a classifier based on a complete extractable set of classifying features, and a pruning module for selecting the group of classifying features from the complete set of classifying features.

39. The system of claim 38, wherein the learning module generates a set of parameters and/or coefficients for classification, and the pruning module selects a sub-set of parameters and/or coefficients for local run-time feature extraction and/or classification on the resource limited client terminal.
